(19) United States
(12) Patent Application Publication
(10) Pub. No.: US 2026/0163376 A1
(43) Pub. Date: Jun. 11, 2026

(54) COMPENSATION SYSTEM INTEGRATED WITH ACTIVE HARMONIC FILTER AND STATIC COMPENSATOR SYSTEMS

(71) Applicant: ELEKTRA ELEKTRONIK SANAYI VE TICARET ANONIM SIRKETI, Istanbul (TR)

(72) Inventor: Veysel Tutku BUYUKDEGIRMENCI, Istanbul (TR)

(73) Assignee: ELEKTRA ELEKTRONIK SANAYI VE TICARET ANONIM SIRKETI, Istanbul (TR)

(21) Appl. No.: 18/709,843

(22) PCT Filed: Dec. 18, 2023
(86) PCT No.: PCT/TR2023/051569

§ 371 Date: May 14, 2024

(30) Foreign Application Priority Data
Aug. 18, 2023 (TR) 2023/010015

(51) Int. Cl. H02J 3/1842; H02J 3/1828

(52) U.S. Cl. CPC H02J 3/1842; H02J 3/1828

(57) ABSTRACT

A hybrid reactive power compensation system is provided. The hybrid reactive power compensation system can work integrated with existing compensation panels, preferably sized as the smallest capacitor step power and can control the compensation steps very quickly. The hybrid system relates to at least one inverter which controls the capacitor steps used in existing compensation systems and includes an active harmonic filter with high dynamic speed, a static VAr generator and STATCOM.

### CROSS-REFERENCE TO THE RELATED APPLICATIONS

This application is the national phase entry of International Application No. PCT/TR2023/051569, filed on Dec. 18, 2023, which is based upon and claims priority to Turkish Patent Application No. 2023/010015, filed on Aug. 18, 2023, the entire contents of which are incorporated herein by reference.

### TECHNICAL FIELD

The invention relates to a hybrid reactive power compensation system comprising an active harmonic filter (AHF), static VAr generator (SVG) and static synchronous compensator (STATCOM), which can work integrated with compensation panels, is preferably sized as the smallest capacitor step power and can control the compensation steps very quickly.

### BACKGROUND

Today, according to the electricity network regulation, which is regulated to provide energy to the consumer in a sufficient, high quality, continuous, economical and environmentally friendly manner, grid-connected facilities have to limit their reactive power use. The reactive current circulating between the generator of the public grid and the consumer converts electrical energy into heat in the electricity distribution system and puts an additional load on generators, transformers, cabling and switchgear. Depending on this situation, energy losses and voltage drops occur. If the value of the reactive current is high, the installed conductors cannot be used at full efficiency for useful power transmission, or it becomes necessary to make larger sizing appropriately. For public institutions, a weak power factor increases the investment and maintenance costs for the power distribution system, and the resulting additional costs are passed on to the responsible persons, in other words, to the electricity consumers with weak power factors. Depending on the reasons mentioned, the power factor level required within the borders of our country is above 0.98. This situation requires the development of very aggressive reactive power compensation systems.

Today, reactive power compensation is carried out with stepped capacitor and shunt reactor steps, and it is necessary to use a reactive power control relay, contactor and/or thyristor switching modules to control, activate and deactivate them. Shunt reactors are compensation elements which create an inductive effect in compensation systems by being activated by the reactive power control relay in case the capacitive load increases, thus compensating the capacitive load. As many capacitor steps as needed for the compensation of the load with inductive characteristics occurring during the day are activated and deactivated, and shunt reactors are used to compensate for the capacitive characteristic occurring at night.

As an example of the state of the art, in order to meet the compensation requirement in a plant with 400 kVAr variable inductive or capacitive loads, a 400 kVAr stepped capacitor bank, a shunt reactor, contactor or thyristor-based switches to activate these steps, and a reactive power control relay for measurements and calculations are needed.

In order to keep the power factor at a level (>0.98) in accordance with the grid regulation, 400 kVAr capacitor banks are realized in steps such as 100, 50, 25, 12.5, 6.25 kVAr. This stepping process means capacitors, switches and cable cross-sections of different sizes. In addition, the plant needs an inductive load in order to keep the power factor above 0.98 due to the capacitive character of devices such as computers and in-plant energy cables used due to the low load at night in the plants. This need for inductive load is met by shunt reactors.

In the state of the art, the capacitor units used are activated and deactivated using a contactor or thyristor step. In compensation systems produced using contactors, the lifespan of the capacitors is short. This is due to the fact that the capacitor is activated and deactivated at a random moment. Since the aforementioned thyristor systems activate the capacitors at the zero-crossing moment, the stress on the capacitor remains at minimum and the life of the capacitors is long. However, since this activating and deactivating process is triggered by the reactive power control relay, the compensation need cannot be met for as long as the reaction time of this device and the delay of the trigger circuit used therein.

With the emphasis on automation of plants and the development of heavy industry, the number of dynamic loads which are activated and deactivated very quickly has increased. In this case, the reactive power control relays currently available in the market are insufficient to meet the compensation need. In order to prevent existing problems and to meet the required capacity, it is necessary to use systems which can perform very fast reactive power compensation such as Active Harmonic Filter, Static VAr Generator and STATCOM in the industry. If the active harmonic filter, Static VAr Generator and STATCOM systems are sized to compensate for the entire load of the plant, the system cost is very high. In addition, it renders the reactive power compensation systems already in the plants inactive.

Therefore, it is necessary to develop a method which minimizes or eliminates the above-mentioned disadvantages in the state of the art and a system which works according to the said method.

### SUMMARY

One of the advantages of the invention is that it can work integrated with existing compensation panels, and active harmonic filter, static VAr generator and STATCOM systems can be sized preferably as much as the smallest capacitor step power in reactive power compensation systems and can control the compensation steps very quickly. Thanks to its very high dynamic speed, the system formed in this way can act as a stepless structure despite the use of stepped capacitor steps, and thus it can both perform reactive power compensation very quickly and offer a cost-effective solution to the user.

Another advantage of the invention is that the active harmonic filter, static VAr generator and STATCOM products can perform both inductive and capacitive reactive power compensation, eliminating the stepping problems mentioned in the state of the art in compensation systems and the need for a shunt reactor. As an example of the need for stepping, the need for compensation in the plant with 400 kVAr variable inductive or capacitive loads can be met with 1 static Var generator with 100 kVAr power and 3 100 kVar capacitor steps. Accordingly, thanks to its very high dynamic speed and its internal controller structure, the need for capacitor steps of different powers, conductors of different sections and reactive power compensation relays is eliminated. In addition, if the capacitive character is dominant in the plants, hybrid compensation systems with shunt reactors can be formed. Due to these technical developments, simultaneous aging of steps can be provided by activating and deactivating the capacitor steps with which it works in an appropriate order and time, thus providing a long-lasting compensation system and minimizing maintenance needs.

Another advantage of the invention is that the problem can be solved with shunt reactors which can be used in a much lower volume instead of shunt reactors which have a large volume and therefore take up more space in compensation panels. In addition, since it is not necessary to use capacitor steps of many different powers, panel size can be saved.

### BRIEF DESCRIPTION OF THE DRAWINGS

FIG. 1 is a representative view of the hybrid compensation system of the present invention.

FIG. 2 is a representative view of the flow diagram of the system of the present invention.

FIG. 3 is a representative view of the flow diagram describing the working principle of the hybrid compensation system of the present invention.

### DEFINITIONS OF REFERENCES IN THE DRAWINGS

In order to better understand the invention, the definitions of the numbers in the drawings are given below:
100. Compensation System
   1. Hybrid system
   2. Capacitor Steps
   3. Inverter
   4. Sensor
   5. Grid distribution transformer
   6. Loads
   7. Power analysis system
   8. Cos Phi reference input
   9. Cos Phi regulator
   10. Current reference generation line
   11. Step controller
   12. Current regulator
   13. Power Converter

### DETAILED DESCRIPTION OF THE EMBODIMENTS

The exemplary embodiments are described in more detail by referring to the accompanying descriptions below. However, the embodiments may be provided in different forms and should not be construed as being limited to the embodiments set forth herein. Instead, these exemplary embodiments are provided for the completeness of this disclosure and to fully convey its scope to those skilled in the art.

The terminology used in this description is intended only to describe a specific exemplary embodiment and is not intended to be limiting. As used herein, the forms “a/an”, “at least”, and “preferably” are intended to include plural forms as well, unless the context clearly indicates otherwise. When the terms “comprises” and/or “including” are used in this specification, the specified features, integers, steps, processes, elements and/or components do not preclude the presence or addition of one or more other features, integers, steps, processes, elements and/or components.

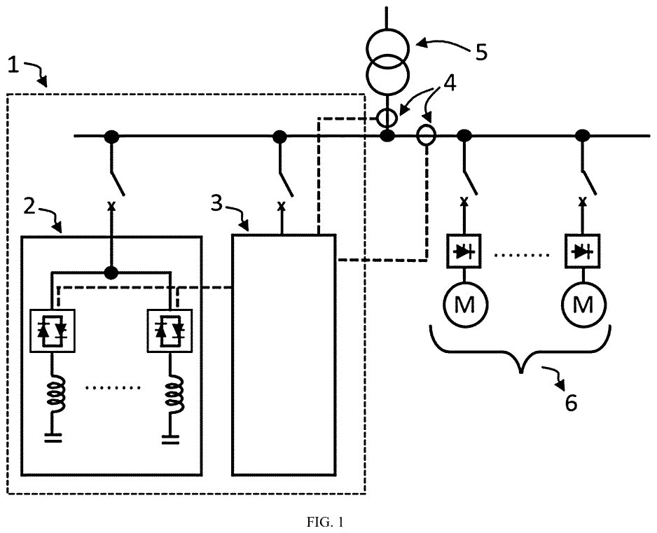

The invention is a hybrid reactive power compensation system (100) which can work integrated with existing compensation panels, preferably sized as the smallest capacitor step power and can control the compensation steps very quickly, characterized in that the hybrid system (1) comprises at least one inverter (3) which controls the capacitor steps (2) used in existing compensation systems and includes an active harmonic filter with high dynamic speed, a static VAr generator and STATCOM. Said inverter (3) is insulated-gate bipolar transistor (IGBT), metal-oxide-semiconductor field effect transistor (MOSFET) or high electron mobility transistor (HEMT) based using silicon (Si), silicon carbide (SiC) or gallium nitride (GaN) technology and comprises at least one direct-current (DC) bus inside and at least one L, LC, LCL or LCLL filter at the output. As seen in the representative drawing in FIG. 1, in the compensation system (100) of the present invention, there is at least one sensor (4) used to measure the currents of the loads in the grid or plant, at least one grid distribution transformer (5) which ensures that the system is supplied from the grid, and at least one load (6) used in the plant.

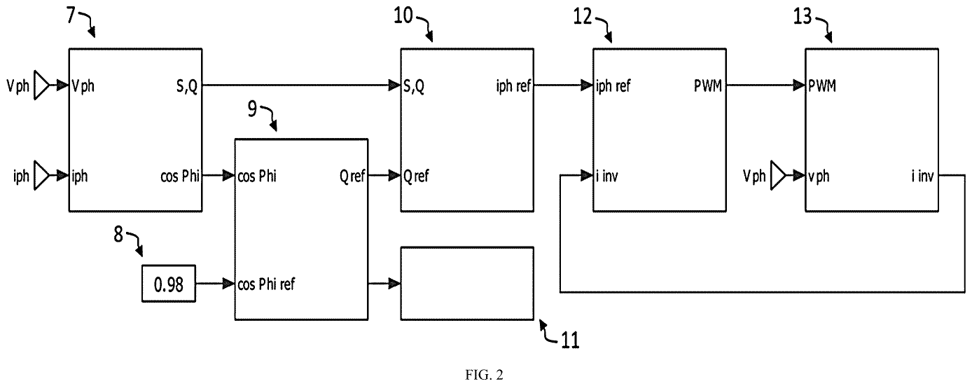

As seen in the representative drawing in FIG. 2, in the said invention, the compensation system performs a power analysis (7), calculates the active, reactive and apparent power delivered to the plant with the voltage and current measurements it receives from the grid and provides the power factor as an output. The Cos Phi reference input (8) is the power factor value targeted by the hybrid compensation in the system. This value can be between −1 and +1. The Cos Phi regulator (9) is the unit which calculates and activates the reactive power current reference required for the hybrid compensation system to work at the targeted power factor and the capacitor steps to be activated. On the current reference generation line (10), it generates the current reference which the power converter (13) should deliver to the grid by calculating the power measurements received and the reference reactive power command sent by the Cos Phi regulator (9). The step controller (11) is the system which activates and deactivates the steps commanded to be activated by the Cos Phi regulator (9). The current regulator (12) is a regulator system which works with the feedback of the power converter (13) current to transmit the current reference coming from the step controller (11) to the grid. This system generates PWM signals to be applied to the power converter (13) at its output. The said power converter (13) is the IGBT, MOSFET or HEMT based inverter system using silicon (Si), silicon carbide (SiC) or gallium nitride (GaN) technology. This system is an AHF, SVG or STATCOM system with a DC bus, an L, LC, LCL or LLCL filter at the output.

The inverter-based system within the scope of the invention can be implemented with a topology of two or more levels. In this way, the effective switching frequency can be increased. On the other hand, the size of the passive filter required for the grid connection can be reduced. In addition, the carrier signals used to generate PWM signals can be generated with:
a phase difference of 120 degrees in case of single-phase connection
a phase difference of 180 degrees in two-phase applications
   and it is ensured that the switching noise above the current obtained at the output is reduced and the required filter size is minimized.

Since the said inverter system (2) has a modular structure, as many products as desired can be connected in parallel and in different phase configurations, thus making the desired asymmetrical current or power sizing possible when necessary.

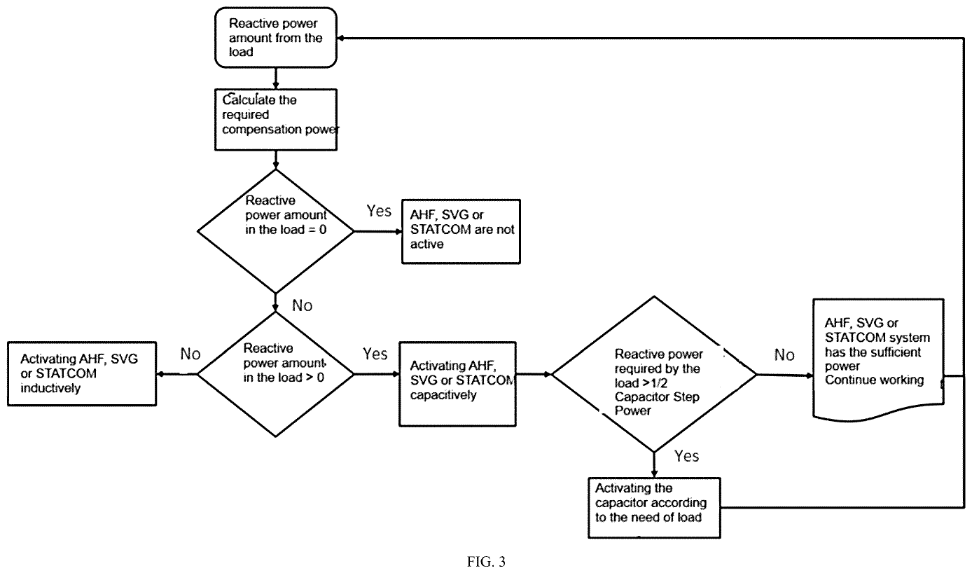

The working diagram of the present invention is shown in the representative drawing in FIG. 3 and works with the method steps given below:
measuring the reactive power requirement of the plant with the measurements acquired by Active Harmonic Filter, Static VAr Generator or STATCOM systems, current transformers connected to the grid or load side or a sensor
calculating the required compensation power according to the received reactive power measurement
deactivating the system if the plant does not require reactive power
providing the reactive power required by the plant by activating the AHF, SVG or STATCOM if the plant requires reactive power
activating the capacitor steps according to the need by the hybrid compensation system if the reactive power required by the plant is higher than half of the power of the Active Harmonic Filter, Static VAr Generator and STATCOM systems used and meeting the compensation need.

### INDUSTRIAL APPLICABILITY OF THE INVENTION

The system of the present invention relates to a hybrid reactive power compensation system comprising an active harmonic filter, static VAr generator and STATCOM, which can work integrated with existing compensation panels, is preferably sized as the smallest capacitor step power and can control the compensation steps very quickly and is industrially applicable.

The invention is not limited to the above exemplary embodiments, and a person skilled in the art can easily reveal other different embodiments of the invention. These should be considered within the scope of the protection requested by the claims of the invention.

What is claimed is:

1. A hybrid reactive power compensation system, wherein the hybrid reactive power compensation system is allowed to work integrated with existing compensation panels, sized as a smallest capacitor step power and is allowed to control compensation steps very quickly, wherein a hybrid system comprises at least one inverter, the at least one inverter controls capacitor steps configured in existing compensation systems and comprises an active harmonic filter with a high dynamic speed, a static VAr generator and static synchronous compensator (STATCOM).

2. The hybrid reactive power compensation system according to claim 1, wherein the at least one inverter is insulated-gate bipolar transistor (IGBT), metal-oxide-semiconductor field effect transistor (MOSFET) or high electron mobility transistor (HEMT) based using silicon (Si), silicon carbide (SiC) or gallium nitride (GaN) technology and comprises at least one direct-current (DC) bus inside and at least one L, LC, LCL or LCLL filter at an output.

3. A working method of a hybrid reactive power compensation system, wherein the working method comprises steps below:
measuring a reactive power requirement of a plant with measurements acquired by active harmonic filter (AHF), static VAr generator (SVG) or STATCOM systems, current transformers connected to a grid or load side or a sensor;
calculating a required compensation power according to a received reactive power measurement;
deactivating a hybrid compensation system if the plant does not require a reactive power;
providing the reactive power required by the plant by activating the AHF, SVG or STATCOM if the plant requires the reactive power;
activating capacitor steps according to a need by the hybrid compensation system if the reactive power required by the plant is higher than half of the just power of the AHF, SVG and STATCOM systems configured and meeting a compensation need.
